(19) United States
(12) Patent Application Publication
(10) Pub. No.: US 2009/0020018 A1
(43) Pub. Date: Jan. 22, 2009

(54) Hot Beverage Center

(76) Inventors: Steven Melzer, Marlboro, NJ (US); Brian Melzer, New York, NY (US); Evan Marc Dash, Port Washington, NY (US)

Correspondence Address: WHITE-WELKER & WELKER, LLC, P.O. BOX 199, CLEAR SPRING, MD, 21722-0199, US

(21) Appl. No.: 12/174,728

(22) Filed: Jul. 17, 2008

Related U.S. Application Data
(60) Provisional application No. 60/950,171, filed on Jul. 17, 2007.

(51) Int. Cl. A47J 31/06

(52) U.S. Cl. 99/288

(57) ABSTRACT

A hot beverage center that utilizes a thermostat in the handle of an electric carafe. The handle thermostat has settings to bring liquids to a precise pre-determined setting for boil, coffee, tea, and cocoa brewing. When the desired temperature is achieved, the thermostat cycles as needed to maintain the liquid at the desired temperature for any period of time. The hot beverage center also uses an interchangeable coffee press filter/tea infuser basket. This unit is designed so that a center rod attaches to a press filter that unscrews so that an interchangeable tea infuser basket can be added. The tea infuser provides that when the center rod is lifted from the top, via a knob, at the point at which the center rod clears the top, it can lay across the top, suspending the tea basket above the water in the carafe.

### CROSS REFERENCE TO RELATED APPLICATIONS

This application claims priority from U.S. Patent Application Ser. No. 60/950,171, entitled “Hot Beverage Center”, filed on Jul. 17, 2008.

### SEQUENCE LISTING OR PROGRAM

Not Applicable

### FEDERALLY SPONSORED RESEARCH

Not Applicable

1. Technical Field of the Invention

The present invention relates generally to a hot beverage machine. More specifically the present invention relates to a hot beverage machine with an interchangeable coffee press filter and tea infuser basket.

2. Background of the Invention

The public's demand for fresh brewed coffee is voracious. Coffee drinkers enjoy their coffee from morning until night, at home and at work. This huge demand for fresh brewed coffee has resulted in the wide spread development and purchase of traditional coffee brewing apparatus such as the gravity-drip coffee maker. Indeed, such devices have become commonplace in most homes and offices.

However, these devices are not well suited for brewing an individual cup of coffee. Coffee must be removed from one receptacle (usually a can or vacuum packed bag) and placed in measured doses into the filter and basket housing of these traditional coffee brewing devices. This inconvenience of measuring ground coffee, cleaning up spent coffee grounds, and then cleaning the device itself can prove to be a significant deterrent to coffee drinkers who only desire a single cup of coffee. Furthermore, it is not feasible for a coffee drinker to brew an entire pot of coffee only to drink one cup, since coffee significantly loses its flavor and taste with time, and thus is not likely to be re-heated and re-used. Conversely, to brew an entire pot of coffee for only one serving proves inefficient and wasteful of expensive coffee grinds.

Because of these drawbacks, coffee drinkers have been forced to resort to the ease and convenience of products like instant coffee that provides a significantly less flavorful cup of coffee than that provided by traditional brew methods. Consumers are also forced to resort to the likes of tea-bag type coffee pouches and microwave brew pouches, such as that disclosed by U.S. Pat. No. 5,135,764 to Clausi, et al. Although less time consuming and complex than traditional coffee brewing methods, these methods and apparatus also result in significant flavor loss since they usually entail submerging a coffee filled pouch into a cup of boiling water, similar to the way one would go about preparing a cup of tea. Unlike a cup of tea that may be properly prepared by immersing filter-encased tea leaves into boiling water, a proper cup of coffee can only result from dripping or percolating boiling water through coffee grinds, as is done with most home coffee machines. By simply immersing a pouch of coffee into boiling water, the water is unable to come into contact with and extract flavor from a sufficient volume of coffee grinds. The result is a weak, flavorless cup of coffee.

Coffee brewing devices present in the art have recognized these drawbacks, and have attempted unsuccessfully to remedy them. The present art discloses individual disposable brewing devices that are mounted directly on a receiving receptacle, as for example in U.S. Pat. No. 4,715,271 to Kitigawa and U.S. Pat. No. 5,055,311 to Brauer Jr., et al. However, these devices have serious drawbacks. U.S. Pat. No. 4,715,271 to Kitigawa discloses a disposable beverage brewer comprising fixed notches along the bottom of the apparatus which are to be seated over the lip of a receiving receptacle. Because these notches are fixed, the number of receptacles that may accept this apparatus is severely limited. These notches also provide inadequate support for the device, thus causing it to be highly prone to tipping and spillage. Also, because of its triangular shape, this device fails to completely enclose the top lip of the receptacle that it is engaged with, and may leak or allow spillage on to the work surface or table.

U.S. Pat. No. 5,055,311 to Brauer Jr. et al. discloses a disposable coffee-brewing apparatus which is independent of and to be suspended above a coffee receptacle. Because this devices relies on support from the same surface that supports the coffee receptacle, it is highly prone to tipping, especially due to its high center of gravity. The force of water being poured from a height into the device can easily cause it to tip. In addition, because it operates independently of the coffee receptacle, the device does not permit the coffee receptacle to be easily moved without having to also move the device. So, for instance, one wishing to move his coffee cup from one location to another would need to find a new suitable platform large enough to support both the coffee receptacle and the device together.

While these units may be suitable for the particular purpose employed, or for general use, they would not be as suitable for the purposes of the present invention as disclosed hereafter. As is well known, the standard type of beverage decanter, and particularly the coffee vessel, such as that which is shown in the Martin U.S. Pat. No. 3,336,856, comprising basically a Pyrex type of glass formed vessel, having the rather standard shape, and with a reduced dimensioned pour spout formed at its upper edge. This type of decanter is rested upon the style of warmer for carafe, as also shown in said Martin patent, and remains there during coffee brewing, or to assure it's warming, after a brewing cycle has been completed.

Generally, and as also can be seen in the Hausam U.S. Pat. No. 3,343,478, the warmers are generally concaved in structure, having a raised marginal rim, so that the convex bottom of the coffee decanter can rest snuggly therein, and have direct and contiguous contact with the hot plate portion of the warmer so as to achieve maximum transfer of heat from the electrical element of the warmer to the brewed coffee, tea, or the like. Similar type of the standard form of beverage warmers are also shown in the Hausam U.S. Pat. No. Des. 212,317, the Reynolds, et al, U.S. Pat. No. 3,479,949, and the Bunn U.S. Pat. No. Re. 25,663, and related type of devices.

There are various style of beverage urns or vessels that are designed for holding a bulk supply of freshly brewed or warmable coffee, or related type of beverages, and such is shown in the Colonna U.S. Pat. No. 2,750,870. In addition, various types of coffee urns for achieving the brewing of coffee in the first instance are shown in the Bruenjas U.S. Pat. No. 3,517,603, U.S. Pat. No. 4,207,809, to Brill, and U.S. Pat. No. 4,309,939, to Stover. But, in most of the embodiments shown, the particular urns are integrally structured into the brewing apparatus itself, and are used primarily for the brewing of the beverage initially, rather than functioning as a vessel for containment of the beverage after it has been brewed, and to be sustained in its warmth for eventual consumption.

### SUMMARY OF THE INVENTION

A hot beverage center that utilizes a thermostat in the handle of an electric carafe. The handle thermostat has settings to bring liquids to precise pre-determined settings for boil, coffee, tea, and cocoa. When the desired temperature is achieved, the thermostat cycles as needed to maintain the liquid at the desired temperature for any period of time. The hot beverage center also uses an interchangeable coffee press filter/tea infuser basket. This unit is designed so that a center rod attaches to a press filter that unscrews so that an interchangeable tea infuser basket can be added. The tea infuser is also designed so that when the center rod is lifted from the top, via a knob, at the point at which the center rod clears the top, it can lay across the top, suspending the tea basket above the water in the carafe. This is an indispensable concept, as it stops the tea from brewing after the desired strength is achieved.

There it is an objective of the present invention to teach a cordless electric water kettle with a thermostat that provides means for precise temperature settings.

It is another objective of the present invention to provide a timer imbedded or integrated in the assembly.

It is yet another objective of the present invention to teach a carafe that has an independent heating seat, which will hold the beverage at ideal drinking temperature without scalding.

It is also an objective of the present invention to provide a hot beverage center that provides means for interchangeable coffee brewing, tea brewing, and cocoa frothing.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an exploded view of the carafe, filter and filter plate of the present invention;

FIG. 2 is an exploded view of the tray top component of the present invention;

FIG. 3 is an exploded view of the infuser of the present invention;

FIG. 4 is an exploded view of the kettle of the present invention;

FIG. 5 is a perspective view of the hot beverage machine of the present invention;

FIG. 6 is a top perspective view of the tray top component of the present invention;

FIGS. 7 and 8 are perspective views of the carafe, filter, and filter plate of the present invention; and

FIG. 9 is perspective view of the filter and tea infuser.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

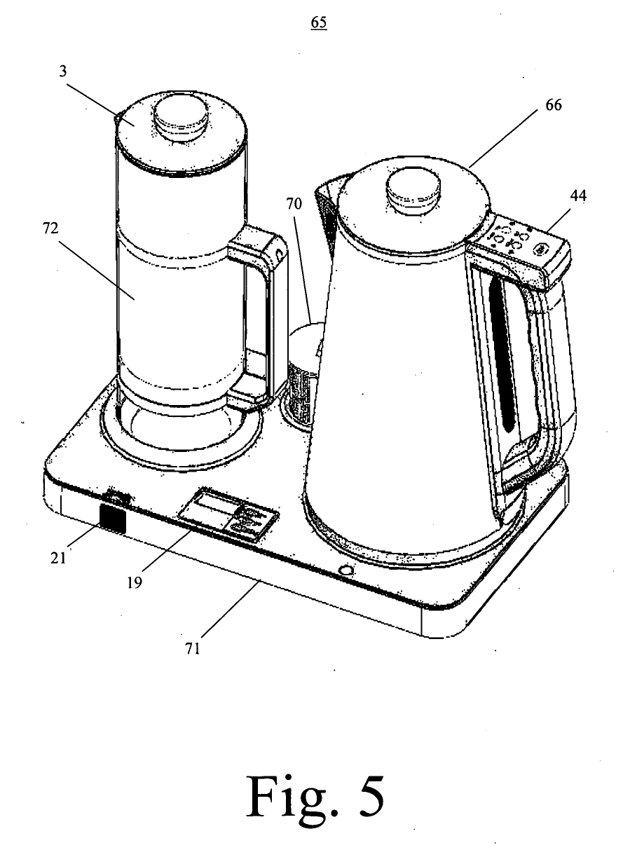

The present invention as shown, in FIG. 5, is a hot beverage center 65 consisting of a tray 21, a kettle 66, a carafe 72 and an infuser 70 in combination for making hot and/or brewing hot beverages.

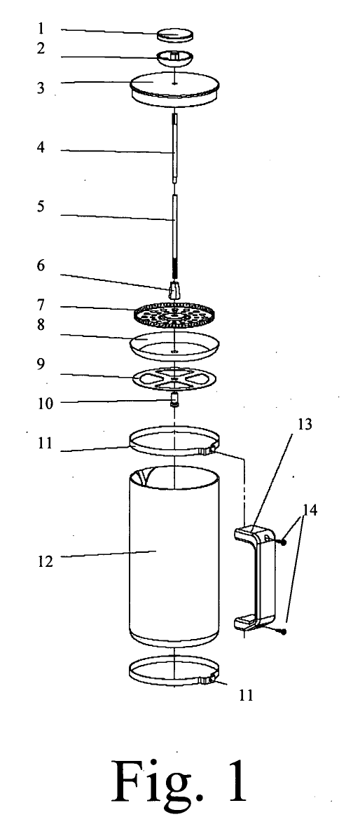

Now referring to FIG. 1, an exploded view of the carafe 72, filter 8, and filter plate 9 of the present invention is shown. The carafe 22 is comprised of a carafe body 12 constructed from high temperature glass, a handle 13 mounted to one a side surface with screws 14 that connect to a carafe belt 11 that is placed around the carafe body 12. The carafe lid 3 is comprised of a knob 2 and knob cover 1 on a first side and a plunger shaft 4 on an opposing side. The plunger shaft's upper portion 4 which is further comprised of a lower portion 5. The lower portion 5 is connected to a brewer plate 7 that rests upon a filter 8 and filter plate 9. The lower portion 5 is threaded so that a filter stopper 6 can be threaded on to the lower portion and the brewer plate 7, filter 8, and filter plate 9 can be secured to it by placing them all on the lower portion 5 and fixing them in place by tightening a stud 10. In use, the carafe is placed on the warmer plate 15 of a tray top 20 for heating.

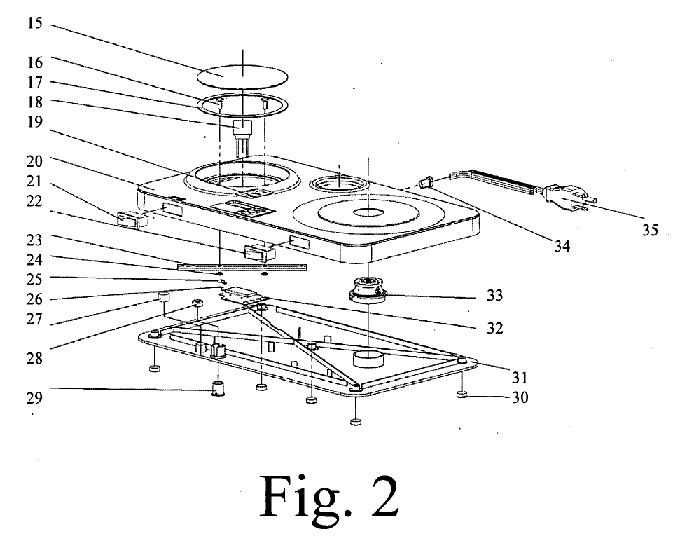

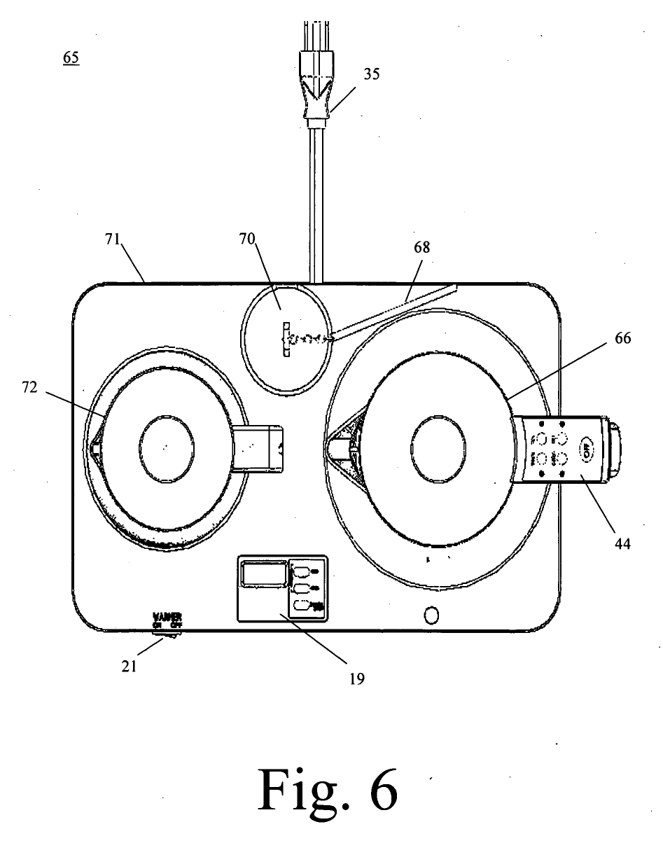

Now referring to FIGS. 2 and 6, the tray 72 of the present invention is shown. The tray 72 consists of a tray top 20 comprised of a warmer plate 15 mounted to the tray top 20 via a seal ring 17 with mounting screws 16 and hex nuts 24 that are secured to a PTC bracket 23 within the tray top 20. The warming tray 15 is heated by a PTC heat conductor 18 also mounted to the PTC bracket 23 within the tray top 20 and controlled by an externally mounted red rocker switch 21. Also located with the tray is a battery 28 and battery contacts 25 and 26 for powering the timer inlay 19 and timer display 32 visible which is visible through the tray top 20. Finally, a buzzer 27 is located within the tray to provide an audible sound when heating is complete. The tray top 20, with additional provisions for a connector plug 33 for engaging a kettle 66, green rocker switch 22 for controlling power to a kettle 66 via the connector plug 33, a power cord 35 and associated strain relief 34, and a battery door 29 is mounted to a tray bottom 31 which has provisions for rubber feet 30.

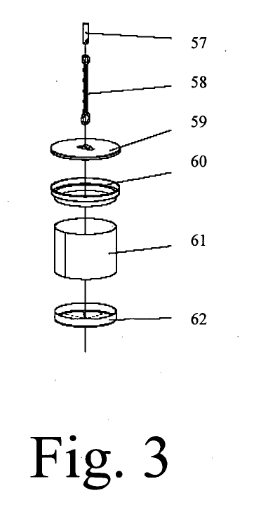

Now referring to FIG. 3, an infuser 67 which rests on the table 72 consists of an infuser body 61 with a base 62 on one end and, on an opposing end, a lid 59 attached to the infuser body 61 via a rim 60 where the lid 59 has an opening through which a chain 58 with a stud 57 on one end can protrude into the infuser body 61 and hang.

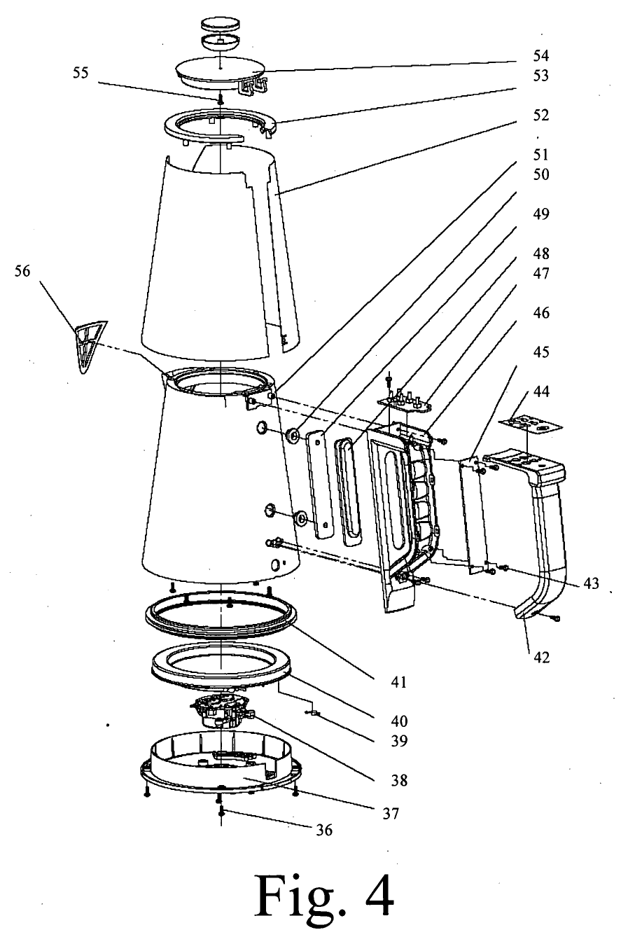

Now referring to FIG. 4, an exploded view of the kettle 66 of the present invention is shown. The kettle 66 consists of a kettle body 51 comprised of a cover 52, rim 53, and lid 54 attached with a hinge means, spout 56, and handle 46. The lid 54 is further comprised of a screwed 55 on knob cover 63 and knob 64. The handle 46 is further comprised of a handle cover 42 and control inlay 44. Within the handle a main PCBA 45 is stored and used to secure the handle to the kettle body 51 with screws 43 as well as a control PCBA 47. Secured between the handle 46 and side of the kettle body 51 is a water meter top 48 and water meter bottom 49, and water meter ring 50. The bottom kettle cover 37 is secure to the kettle 66 via screws 36 and secures between the bottom kettle cover 37 and bottom surface of the kettle 66 a temperature sensor 39, heater assembly 40, and 0-ring 41 and connector socket 38 which enables connection with the connector plug 33 of the tray top 20 and provides a connector for electricity to flow from the tray top 20 to the heating assembly 40 of the kettle 66.

A hot beverage center 65 that utilizes a thermostat or heating assembly 40 in the handle 46 of an electric carafe or kettle 66. The handle thermostat or heating assembly 40 has settings to bring liquids to precise pre-determined settings for boil, coffee, tea, and cocoa. When the desired temperature is achieved, the thermostat cycles as needed to maintain the liquid at the desired temperature for any period of time. The hot beverage center 65 also uses an interchangeable coffee press filter/tea infuser basket 67.

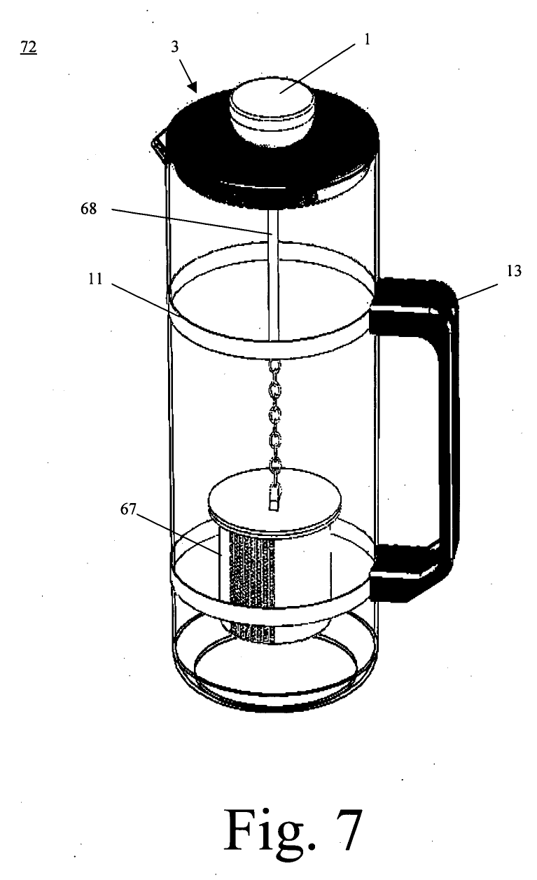

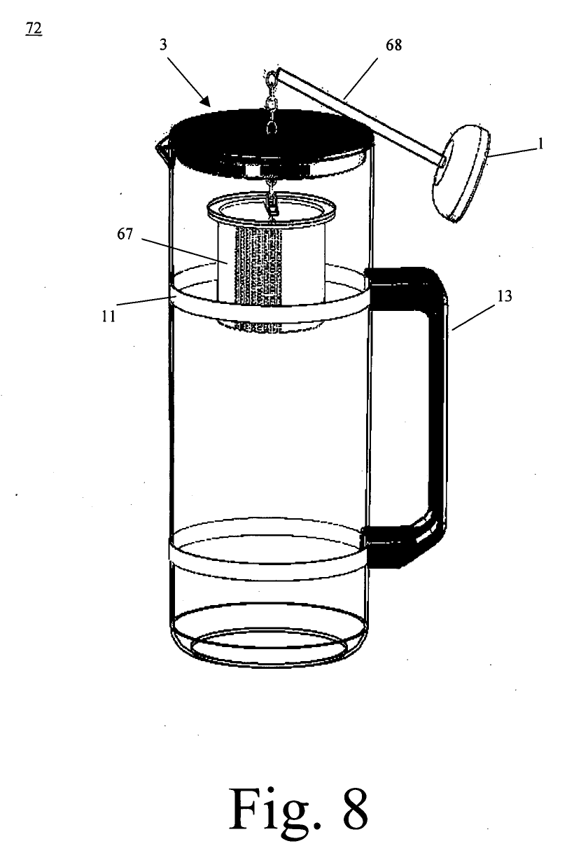

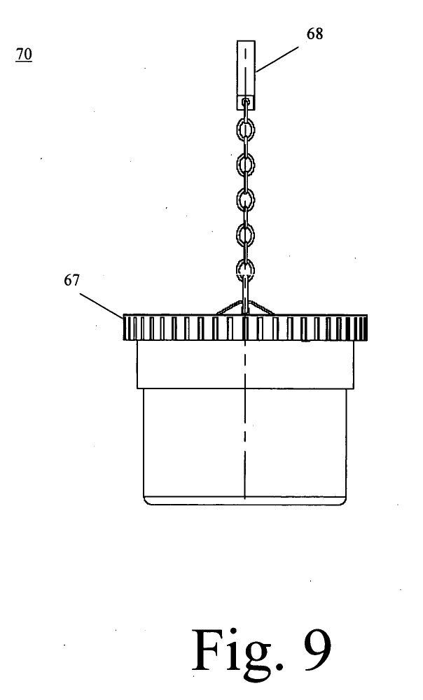

Now referring to FIGS. 7, 8, and 9 the tea infuser basket 67 is designed so that a center rod 68 attaches to a press filter 69 that unscrews so that an interchangeable tea infuser basket 67 can be added. The tea infuser 70 is also designed so that when the center rod 68 is lifted from the top, via a knob 2, at the point at which the center rod 68 clears the top 2, it can lay across the top of the carafe 12, suspending the tea basket 67 above the water in the carafe 12. This is an indispensable concept, as it stops the tea from brewing after the desired strength is achieved.

The hot beverage 65 center consists of a cordless electric water kettle 66 with a thermostat or heating assembly 40 that provides means for precise temperature settings. A timer 47 is imbedded in the assembly to control the electric water kettle 66.

The hot beverage center 65 also consists of a carafe or carafe 12 that has an independent heating seat or warmer plate 15 that holds a beverage at ideal drinking temperature without scalding and also provides means for interchangeable coffee brewing, tea brewing, and cocoa frothing. A basket 67 is attached to the carafe or carafe rod 68 and suspended in the water which can be lifted out.

In addition, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A hot beverage center consisting of:
an electrically powered tray consisting of a warmer plate controlled by an externally mounted switch providing means for warming a carafe, a timer display, and a connector plug providing means for engaging a kettle controlled by an externally mounted switch controlling power to a kettle;
a cordless electric kettle with a thermostat that provides means for precise temperature settings and a connector socket for engaging the connector plug of the powered tray;
a timer imbedded in the kettle assembly to control the kettle's thermostat;
a carafe for engaging the warmer plate providing means for holding a beverage at ideal drinking temperature; and
an infuser basket comprised of an infuser body with a base on one end and, on an opposing end, a lid attached to the infuser body via a rim where the lid has an opening through which a chain with a stud on one end can protrude into the infuser body and hang.

2. The hot beverage center of claim 2, wherein the carafe is further comprised of a body constructed from high temperature glass in a cylindrical shape;
a handle mounted to an external side surface;
a lid comprised of a knob and knob cover on a first side and a plunger shaft on an opposing side;
the plunger shaft is comprised of center rod which is further connected to a brewer plate that rests upon a filter and filter plate creating a press filter;
the lower portion is threaded so that a filter stopper can be threaded on to the lower portion and the press filter can be secured to it by tightening a threaded stud to the lower portion.

3. The hot beverage center of claim 2, wherein
the center rod that attaches to a press filter that unscrews so that an interchangeable infuser basket can be added; and
a infuser basket attaches to the carafe rod and is suspended in the liquid but can be lifted out to stop brewing with removing the lid.

4. The hot beverage center of claim 3, wherein
wherein when the center rod is lifted from the top, via a knob, at the point at which the center rod clears the top, it can lay across the top, suspending the basket above the liquid in the carafe providing means to stop the liquid from brewing after the desired strength is achieved.

5. The hot beverage center of claim 1, wherein the kettle consists of:
a kettle body comprised of a cover, rim, lid, filter spout, bottom, and handle;
the lid is further comprised of a knob cover and knob and is attached to the kettle body via hinge mean;
the handle is further comprised of a handle cover, control inlay, main PCBA, control PCBA, and liquid meter secured to the kettle body; and
a bottom kettle cover consists of a temperature sensor, heater assembly, and connector socket which provides means for connection with the connector plug of the tray.

6. The hot beverage center of claim 5, wherein
the kettle's heating assembly has settings to bring liquids to precise predetermined settings for boil, coffee, tea, and cocoa; and
when the desired temperature is achieved, the thermostat cycles as needed to maintain the liquid at the desired temperature for any period of time.

7. The hot beverage center of claim 2, wherein the press filter is interchangeable with the infuser basket.

8. The hot beverage center of claim 7, wherein the center rod of the infuser basket to a press filter that unscrews so that an interchangeable infuser basket can be added.

9. The hot beverage center of claim 7, wherein when the center rod of the infuser is lifted from the top through the lid of the carafe, via a knob, at the point at which the center rod clears the top, it can lay across the top of the carafe, suspending the infuser basket above the liquid in the carafe.
